(19) United States
(12) Patent Application Publication
(10) Pub. No.: US 2009/0085836 A1
(43) Pub. Date: Apr. 2, 2009

(54) PLASMA DISPLAY, AND DRIVING METHOD THEREOF

(76) Inventors: Jung-Soo An, Suwon-si (KR); Suk-Ki Kim, Suwon-si (KR)

Correspondence Address: CHRISTIE, PARKER & HALE, LLP, PO BOX 7068, PASADENA, CA, 91109-7068, US

(21) Appl. No.: 12/184,066

(22) Filed: Jul. 31, 2008

(30) Foreign Application Priority Data
Oct. 1, 2007 (KR) 10-2007-0098751

(51) Int. Cl. G09G 3/28

(52) U.S. Cl. 345/60

(57) ABSTRACT

A three electrode plasma display device utilizing an auxiliary reset period and, during a sustain period, sustain pulses of variable widths. In the auxiliary reset period, a voltage at the scan electrode is gradually increased from a first voltage to a second voltage, and then gradually decreased from a third voltage to a fourth voltage. In the sustain period, a plurality of sustain pulses are alternately applied to a scan electrode and a sustain electrode. The sustain pulses include a first sustain pulse group and a second sustain pulse group, where the second sustain pulse group includes at least the last sustain pulse in the sustain period. The width of the sustain pulses included in the second sustain pulse group are wider than a width of the sustain pulses included in the first sustain pulse group.

### CROSS-REFERENCE TO RELATED APPLICATION

This application claims priority to and the benefit of Korean Patent Application No. 10-2007-0098751, filed in the Korean Intellectual Property Office on Oct. 1, 2007, the entire content of which is incorporated herein by reference.

### BACKGROUND

1. Field

The present invention relates to a plasma display device and a driving method thereof.

2. Description of the Related Art

A plasma display device utilizes a plasma display panel (PDP) to display characters or images by controlling a plasma generated according to a gas discharge.

The plasma display device displays an image frame that includes a plurality of subfields, each subfield having a luminance weight value. Each subfield includes a reset period, an address period, and a sustain period. A discharge cell (hereinafter referred to as a “cell”) is initialized by a reset discharge during the reset period of each subfield, and a discharge cell is selected as a light emitting cell or a non-light emitting cell by an address discharge during the address period of each subfield. The light emitting cell is sustain discharged during a sustain period of each subfield causing an image to be displayed. The reset period discussed above may be either a main reset period or an auxiliary reset period. The reset discharge is generated in all the discharge cells during the main reset period, but during the auxiliary reset period, the reset discharge is only generated in the discharge cells having undergone the sustain discharge in the previous subfield (i.e., the light emitting cells).

Generally, the sustain discharge ends with a high voltage (e.g., a sustain pulse) applied to a scan electrode. In the auxiliary reset period, a voltage of the scan electrode is gradually decreased while a positive voltage is applied to a sustain electrode and a ground voltage is applied to an address electrode. However, the plasma display has a characteristic in which a discharge delay time is reduced and discharge firing voltage is lower as the temperature of plasma display panel becomes higher. Thus, when the voltage of the scan electrode is decreased, many wall charges formed on the electrodes are erased. In addition, during the address period, the wall charges of discharge cells addressed later are erased even more. In this way, in a discharge cell with an insufficient wall charge, a weak address discharge may be generated, thereby generating a low discharge and resulting in a weak sustain discharge.

The above information disclosed in this Background section is only for enhancement of understanding of the background of the invention and therefore it may contain information that does not form the prior art that is already known in this country to a person of ordinary skill in the art.

### SUMMARY OF THE INVENTION

A plasma display according to an exemplary embodiment of the present invention utilizes an auxiliary reset period and sustain pulses having varying widths. One exemplary embodiment of the present invention includes a method of driving a plasma display including a first electrode, a second electrode, a third electrode crossing the first electrode and the second electrode, and a discharge cell formed by the first electrode, the second electrode, and the third electrode. The plasma display displays an image during a frame having a plurality of subfields, each subfield having a reset period, an address period, and a sustain period. Each reset period is either a main reset period, or an auxiliary reset period, described in further detail below. The plurality of subfields includes at least a first subfield group. According to the method, a plurality of sustain pulses are alternately applied to the first electrode and the second electrode during the sustain period of each subfield of the first subfield group. During the auxiliary reset period of a first subfield from among the first subfield group, a voltage of the first electrode is gradually increased from a first voltage to a second voltage, and the voltage at the first electrode is gradually decreased from a third voltage to a fourth voltage during the auxiliary reset period. In the first subfield of the first subfield group, the plurality of sustain pulses includes a first pulse group and a second pulse group, where the second pulse group includes at least a last sustain pulse, and a width of each sustain pulse of the second pulse group is wider than a width of each sustain pulse of the first pulse group.

According to another exemplary embodiment of the present invention, in which the plurality of subfields includes a first subfield group, a second subfield group, and a third subfield group, a voltage difference between the second electrode and the first electrode is gradually increased from a first voltage to a second voltage, and the voltage difference is gradually decreased from a third voltage to a fourth voltage during the reset period of each subfield of the first subfield group. Further, the voltage difference is gradually increased from a fifth voltage that is lower than the second voltage to a sixth voltage, and the voltage difference is gradually decreased from a seventh voltage to a eighth voltage during a reset period of a plurality of each subfield of the second subfield group. During a first portion of the sustain period of the third subfield group, a plurality of first sustain pulses having a first width are alternately applied to the first electrode and the second electrode just before the second subfield group, and during a second portion of the sustain period of the third subfield group, after the first portion of the sustain period of the third subfield group, at least one second sustain pulse having a wider width than the first width is alternately applied to the first electrode and the second electrode.

Still another exemplary embodiment of the present invention discloses a plasma display including a plurality of discharge cells, a controller, and a driver. Each discharge cell is selected as either a light emitting cell or a non-light emitting cell during the address period of each subfield. The controller outputs control signals to a driver, and the driver applies a plurality of sustain pulses to the discharge cells during the sustain period, the plurality of sustain pulses comprising a first sustain pulse group and a second sustain pulse group, the second sustain pulse group comprising a wider width than a width of the sustain pulses of the first sustain pulse group, and the second sustain pulse group being applied after the first sustain pulse group. The controller is configured such that a first discharge cell among the plurality of discharge cells that is selected as the light emitting cell is sustain discharged during sustain periods of a first subfield group of the plurality of subfields, and a reset waveform is applied to the first discharge cell in the reset periods of a second subfield group of the plurality of subfields, the subfields of the second subfield group being contiguous to the sustain periods of the first subfield group. The reset waveform for reset discharging is applied to the light emitting cell during the reset periods of the first subfield group.

### BRIEF DESCRIPTION OF THE DRAWINGS

FIG. 1 is a simplified schematic diagram illustrating a plasma display according to an exemplary embodiment of the present invention.

FIG. 2 is a table illustrating a driving method of the plasma display device according to an exemplary embodiment of the present invention.

FIG. 3-FIG. 6 are diagrams illustrating driving waveforms of the plasma display device according to the first to fourth exemplary embodiments of the present invention, respectively.

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

The plasma display device and its driving method according to the exemplary embodiment of the present invention will now be described in detail.

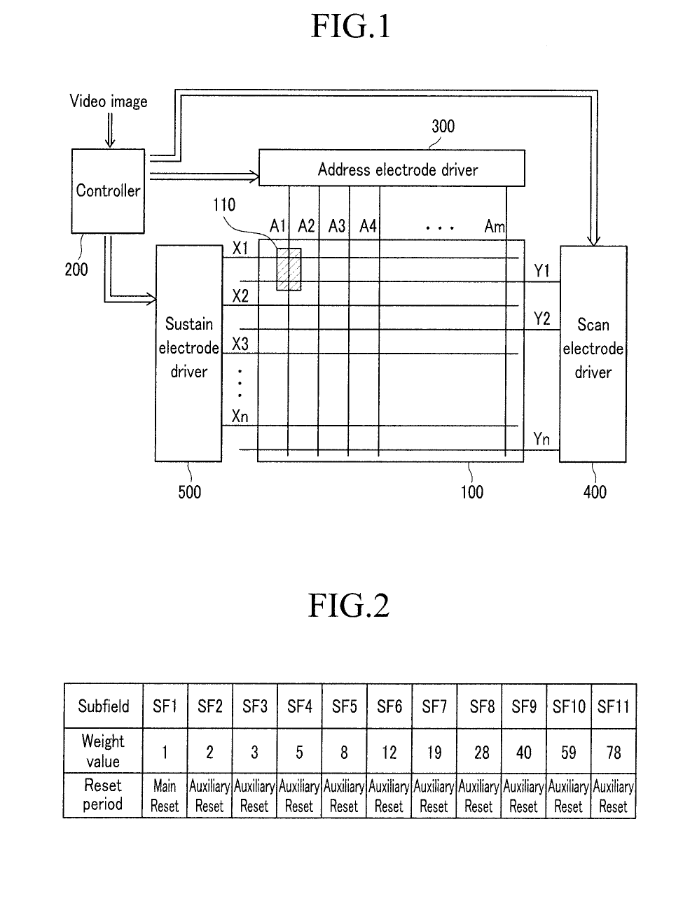

FIG. 1 is a simplified schematic diagram illustrating a plasma display device according to the exemplary embodiment of the present invention.

As shown in FIG. 1, the plasma display device according to the exemplary embodiment of the present invention includes a plasma display panel 100, a controller 200, an address electrode driver 300, a scan electrode driver 400, and a sustain electrode driver 500.

The plasma display panel (PDP)100 includes a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as “Y electrodes” hereinafter) extending in a row direction, forming pairs. In general, the X electrodes X1-Xn are formed to correspond to the respective Y electrodes Y1-Yn, and the X electrodes X1-Xn and the Y electrodes Y1-Yn perform a display operation during a sustain period in order to display an image. The Y electrodes Y1-Yn and the X electrodes X1-Xn are disposed to cross the A electrodes A1-Am. Discharge spaces present at each crossing point of the A electrodes A1-Am and the X and Y electrodes X1-Xn and Y1-Yn form discharge cells 110. The structure of the PDP 100 shows one example, and a panel with a different structure to which driving waveforms described herein below can be applied can be also applicable in the present invention.

The controller 200 receives a video signal from the outside, and outputs an A electrode driving control signal, an X electrode driving control signal, and a Y electrode driving control signal. The controller 200 drives a frame by dividing it into a plurality of subfields each having a luminance weight value.

The address electrode driver 300 receives the A electrode driving control signal from the controller 200 and applies a driving voltage to the A electrodes.

The scan electrode driver 400 receives the Y electrode driving control signal from the controller 200 and applies a driving voltage to the Y electrodes.

The sustain electrode driver 500 receives the X electrode driving control signal from the controller 200 and applies a driving voltage to the X electrodes.

FIG. 2 is a table illustrating a driving method of the plasma display device according to an exemplary embodiment of the present invention.

As shown in FIG. 2, a frame may include a plurality of subfields each having a weight value. According to the exemplary embodiment of FIG. 2, one frame includes 11 subfields SF1-SF11 respectively having weight values 1, 2, 3, 5, 8, 12, 19, 28, 40, 59, and 78, as shown in FIG. 2, and each weight value of the 11 subfields SF1-SF11 may be set differently to what is shown in FIG. 2. Each of the subfields SF1-SF11 includes a reset period, an address period, and a sustain period. At this time, the reset period of a portion of subfields among the plurality of subfields may be a main reset period, and the reset period of the remaining subfields among the plurality of subfields may be an auxiliary reset period. In this embodiment, illustrated in FIG. 2, the reset period of subfield SF1 is described as a main reset period, and the reset period of subfields SF2-SF11 is described as an auxiliary reset period.

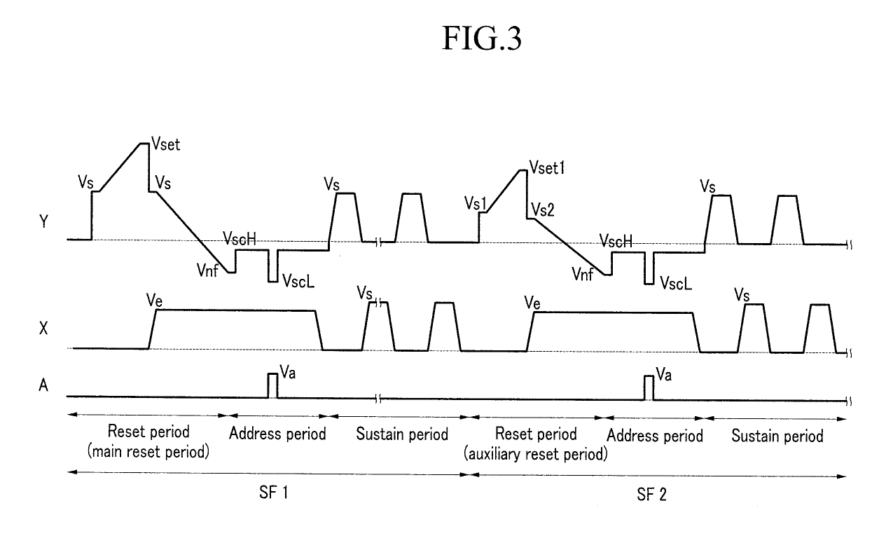

FIG. 3 is diagram illustrating driving waveforms of the plasma display device according to the first exemplary embodiment of the present invention. FIG. 3 shows two subfields SF1 and SF2 among the plurality of subfields within one frame. Furthermore, in FIG. 3, the driving waveform will be described with a discharge cell 110 formed by an A electrode, an X electrode, and a Y electrode as a reference.

As shown in FIG. 3, in the main reset period of subfield SF1, the address electrode driver 300 and the sustain electrode driver 500 bias the A electrode and the X electrode to a reference voltage (e.g., 0V), respectively, and the scan electrode driver 400 gradually increases the voltage of the Y electrode from a voltage Vs to a voltage Vset. In FIG. 3, the voltage of the Y electrode is described to increase with ramp pattern. Then, a weak discharge is generated between the Y electrode and the X electrode and between the Y electrode and the A electrode while the voltage of the Y electrode is increasing, and negative (−) wall charges are formed at the Y electrode and positive (+) wall charges are formed at the X and A electrodes. At this time, the Vset voltage may be set to be larger than a discharge firing voltage between the X electrode and the Y electrode in order to induce discharge at all discharge cells 110.

Subsequently, in the main reset period of the first subfield, the sustain electrode driver 400 biases the X electrode with a Ve voltage, and the scan electrode driver 500 gradually decreases the voltage of the Y electrode from a Vs voltage to a Vnf voltage during a falling period. In FIG. 3, the voltage of the Y electrode is described to decrease with a ramp pattern. Then, weak discharge is induced between the Y electrode and the X electrode and between the Y electrode and the A electrode while the voltage of the Y electrode is decreasing, and the negative (−) wall charges formed at the Y electrode and the positive (+) wall charges formed at the X electrode and the A electrode are substantially erased. In general, the voltage of Ve and the voltage of Vnf may be set so that the wall voltage between the Y electrode and the X electrode is near 0V in order to prevent a misfiring discharge in a non-light emitting cell (i.e., a discharge cell that was not selected during the address period, discussed below). That is, a voltage of (Ve-Vnf) is set to be close to the discharge firing voltage between the Y electrode and the X electrode.

In an address period, in order to select a discharge cell 110 to be a light emitting cell, the sustain electrode driver 500 maintains the voltage of the X electrode at the Ve voltage, and the scan electrode driver 400 and the address electrode driver 300 apply a scan pulse having the VscL voltage and an address pulse having the Va voltage to the Y electrode and the A electrode, respectively. Further, the scan electrode driver 400 biases an unselected Y electrode with a VscH voltage that is higher than a VscL voltage, and the address electrode driver 300 biases an A electrode of a non-light emitting cell with a ground voltage. At this time, the voltage VscL is set to have a level that is equal to or lower than the voltage Vnf.

In detail, in the address period, the scan electrode driver 400 and the address electrode driver 300 apply a scan pulse to the Y electrode (Y1 in FIG. 1) of a first row and at the same time apply address pulses to the A electrodes positioned at light emitting cells in the first row. Then, address discharges occur between the Y electrodes of the first row and the A electrodes to which the address pulses have been applied, forming positive (+) wall charges in the Y electrode and negative (−) wall charges in the A and X electrodes. Subsequently, while applying a scan pulse to the Y electrode (Y2 in FIG. 1) of a second row, the scan electrode driver 400 and the address electrode driver 300 apply address pulses to the A electrodes positioned at light emitting cells of the second row.

Then, address discharges occur at discharge cells 110 formed by the A electrodes to which the address pulses have been applied and the Y electrode of the second row, forming wall charges in the light emitting cells. Likewise, by sequentially applying scan pulses to the Y electrodes of the remaining rows, the scan electrode driver 400 and the address electrode driver 300 apply address pulses to the A electrodes positioned at light emitting cells to form wall charges.

In the sustain period, the scan electrode driver 400 applies a sustain pulse alternately having a high level voltage (Vs in FIG. 3) and a low level voltage (0V in FIG. 3) to the Y electrodes a number of times corresponding to a weight value of the corresponding subfield. In addition, the sustain electrode driver 500 applies a sustain pulse to the X electrodes in a phase opposite to that of the sustain pulse applied to the Y electrodes. That is, 0V is applied to the X electrode when a Vs voltage is applied to the Y electrode, and the Vs voltage is applied to the X electrode when 0V is applied to the Y electrode.

In this case, a voltage difference between the Y electrode and the X electrode alternately is a Vs voltage and a −Vs voltage. Accordingly, the sustain discharge is repeatedly induced at light emitting cells as many times as the number corresponding to the weight value.

In the auxiliary reset period of the second subfield, the sustain electrode driver 500 applies the reference voltage (e.g., 0V) to the X electrodes, and the scan electrode driver 400 gradually increases the voltage of the Y electrodes from a voltage Vs1 to a voltage Vset1. A weak discharge is generated between the Y electrode and the X electrode when a sum of the voltage at the Y electrode and the wall voltage between the X electrode and the Y electrode exceeds the discharge firing voltage between the X electrode and the Y electrode.

In addition, while the voltage at the Y electrode increases, a weak discharge is also generated between the Y electrode and the A electrode when a sum of the voltage at the Y electrode and the wall voltage between the Y electrode and the A electrode exceeds the discharge firing voltage between the Y electrode and the A electrode. Thus, the negative (−) wall charges in the Y electrode of a light emitting cell are formed, and positive (+) wall charges in the X electrode and A electrode of the light emitting cell are formed.

The reset period of the second subfield according to this embodiment is an auxiliary reset period. Therefore, the reset discharge is generated when the sustain discharge is generated in a previous subfield. That is, the Vset1 voltage may be set so that a reset discharge is not generated when a sustain discharge is not generated in the previous subfield. However, because the reset discharge may be generated in all the discharge cells 110 when the voltage at the Y electrode increases to the voltage of Vset as described above, the Vset1 voltage may be established to be lower than the Vset voltage.

Subsequently, during the auxiliary reset period, the sustain electrode driver 500 and the address electrode driver 300 apply the voltage Ve and the reference voltage (e.g., 0V) to the X electrode and the A electrode, respectively, and the scan electrode driver 400 gradually decreases the voltage of the Y electrodes from a voltage Vs2 to the voltage Vnf. Because gradually decreasing the voltage at the Y electrode from the voltage of Vset1 to the voltage of Vnf would increase the length of the reset period, the voltage at the Y electrode is decreased from the voltage of Vs2 which is a level that does not cause the discharge. While the voltage of the Y electrodes is decreasing, a weak discharge is generated between the Y and X electrodes of the light emitting cell and between the Y and A electrodes of the light emitting cell. Thus, the negative (−) wall charges formed in the Y electrodes are substantially erased, and the positive (+) wall charges formed in the X and A electrodes are substantially erased.

Next, in the second subfield, the light emitting cells and non-light emitting cells are selected by the address discharge in the address period, and the sustain discharge operation is performed for light emitting cells in the sustain period.

As described above, according to the first exemplary embodiment of the invention, since the weak discharge occurs in the light emitting cells such that wall charges are set before the voltage of the Y electrode is gradually decreased in the auxiliary reset period, a low discharge generated by a weak address discharge of the light emitting cells may be prevented. Meanwhile, when sufficient wall charges are formed in the light emitting cells before the auxiliary reset period, the weak discharge may be easily generated in the auxiliary reset period.

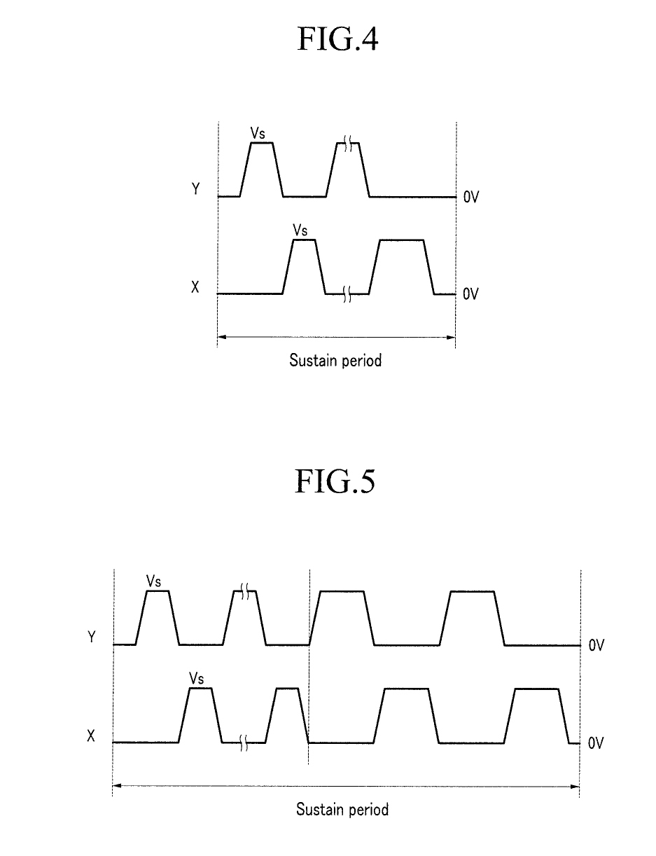

Exemplary embodiments for forming the sufficient wall charges in the light emitting cells before the auxiliary reset period will be described with reference to FIG. 4 to FIG. 6 below.

FIG. 4-FIG. 6 are diagrams illustrating driving waveforms of the plasma display device according to the second to fourth exemplary embodiment of the present invention, respectively.

In FIG. 4 to FIG. 6, the driving waveform of the sustain period in only one subfield is shown.

Firstly, as shown in FIG. 4, according to the second exemplary embodiment of the present invention, in the sustain period of a subfield (e.g., SF1 in FIG. 3) just before a subfield (e.g., SF2 in FIG. 3) having the auxiliary reset period, the sustain electrode driver 500 applies a last sustain pulse that is applied to the X electrode with a width that is wider than a width of the other sustain pulses that are applied to the X electrode. In this case, since the X electrode maintains the Vs voltage such that a period in which a difference between a voltage of the X electrode and a voltage of the Y electrode and a difference between a voltage of the X electrode and a voltage of the A electrode is relatively long, sufficient wall charges are formed in the discharge cell 110 by the last sustain discharge.

Further, as shown in FIG. 5, according to the third exemplary embodiment of the present invention, in the sustain period of a subfield (e.g., SF1 in FIG. 3) just before a subfield (e.g., SF2 in FIG. 3) having the auxiliary reset period, the scan electrode driver 400 may apply at least one sustain pulse including a last sustain pulse that is applied to the Y electrode with a width that is wider than a width of the other sustain pulse(s) applied to the Y electrode. In addition, the sustain electrode driver 500 may apply at least one sustain pulse including a last sustain pulse that is applied to the X electrode with a width that is wider than a width of the other sustain pulse(s) applied to the X electrode.

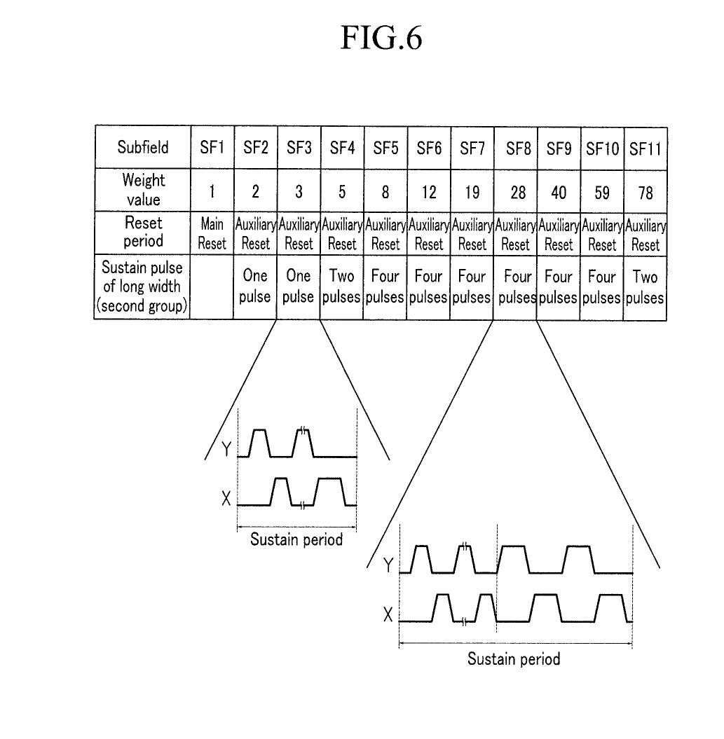

In general, since the number of sustain pulses in a subfield having a low weight value is less than the number of sustain pulses in a subfield having a high weight value, sufficient wall charges may not be formed in the discharge cell 110. Thus, as shown in FIG. 6, according to the fourth exemplary embodiment of the present invention, the scan electrode driver 400 and the sustain electrode driver 500 apply the sustain pulse having a wide width to the Y electrode and X electrode as the weight value of the subfields becomes higher.

That is, according to the fourth exemplary embodiment of the present invention, the controller (200 in FIG. 1) divides a plurality of sustain pulses applied to Y electrodes and X electrodes in the sustain period into at least two groups, allocates general sustain pulses to a previous group (a first group), and allocates sustain pulses having wider widths to a next group (a second group).

In addition, the controller 200 allocates a number of sustain pulses having a wide width to a group including one subfield to be less than the number of sustain pulses having a wide width in the other subfield having a higher weight value than the one subfield. FIG. 6 shows no sustain pulse having a wide width in the subfield SF1, one sustain pulse having a wide width in the subfields SF2-SF3, two sustain pulses having a wide width in the subfield SF4, and four sustain pulses having a wide width in the subfields SF5-SF10. In this case, sufficient wall charges may be formed as the weight value of the subfields becomes higher. Accordingly, a weak discharge may be easily generated in the auxiliary reset period.

Meanwhile, since a main reset is performed in the next subfield after a last subfield of one frame (e.g., SF1 in the subsequent frame), it is not necessary for the controller 200 to allocate a sustain pulse having a wide width to the last subfield SF11. However, in some embodiments, such as that illustrated in FIG. 6, the number of sustain pulses having a wide width in the last subfield (i.e., SF11) may simply be reduced.

According to various exemplary embodiments the present invention as described above, during the auxiliary reset period, since sufficient wall charges are formed in the light emitting cells, the plasma display device can improve the low discharge at a high temperature.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method of driving a plasma display including a first electrode, a second electrode, a third electrode crossing the first electrode and the second electrode, and a discharge cell formed by the first electrode, the second electrode, and the third electrode, wherein the plasma display is configured to display an image during a frame comprising a plurality of subfields, each subfield comprising a reset period, an address period, and a sustain period, each reset period comprising a main reset period or an auxiliary reset period, the plurality of subfields comprising a first subfield group, the method comprising:
alternately applying a plurality of sustain pulses to the first electrode and the second electrode during the sustain period of each subfield of the first subfield group;
gradually increasing a voltage of the first electrode from a first voltage to a second voltage during the auxiliary reset period of a first subfield of the first subfield group; and
gradually decreasing the voltage of the first electrode from a third voltage to a fourth voltage during the auxiliary reset period of the first subfield of the first subfield group,
wherein, in the first subfield of the first subfield group, the plurality of sustain pulses comprises a first pulse group and a second pulse group, the second pulse group comprises at least a last sustain pulse, and a width of each sustain pulse of the second pulse group is wider than a width of each sustain pulse of the first pulse group.

2. The method of claim 1, wherein, in the first subfield of the first subfield group, a number of sustain pulses in the second pulse group depends on a weight value of the first subfield.

3. The method of claim 2, wherein:
the first subfield group comprises a second subfield and a third subfield of the plurality of subfields;
the third subfield having a higher weight value than the second subfield; and
a number of sustain pulses in the second pulse group in the second subfield is less than a number of sustain pulses in the second pulse group in the third subfield.

4. The method of claim 1, wherein:
the discharge cell is selected as either a light emitting cell or a non-light emitting cell during the address period of each subfield; and
if the discharge cell is the non-light emitting cell in the first subfield just prior to the auxiliary reset period, the discharge cell is not discharged during the auxiliary reset period.

5. The method of claim 4, further comprising:
applying a fifth voltage to the second electrode while the voltage of the first electrode is gradually increased during the auxiliary reset period, and
applying a sixth voltage that is higher than the fifth voltage to the second electrode while the voltage of the first electrode is gradually decreased during the auxiliary reset period.

6. The method of claim 5, further comprising:
during the main reset period of a fourth subfield among the plurality of subfields,
gradually increasing a voltage of the first electrode from an eighth voltage to a ninth voltage while applying a seventh voltage to the second electrode; and
gradually decreasing a voltage of the first electrode from an eleventh voltage to a twelfth voltage while applying a tenth voltage that is higher than the seventh voltage to the second electrode,
wherein the difference between the second voltage and the fifth voltage is smaller than the difference between the ninth voltage and the seventh voltage.

7. A method of driving a plasma display including a first electrode, a second electrode, a third electrode crossing the first electrode and the second electrode, and a discharge cell formed by the first electrode, the second electrode, and the third electrode, wherein the plasma display is configured to display an image during a frame comprising a plurality of subfields, each subfield comprising a reset period, an address period, and a sustain period, each reset period comprising a main reset period or an auxiliary reset period, the plurality of subfields comprising a first subfield group, a second subfield group, and a third subfield group, the method comprising:
gradually increasing a voltage difference between the second electrode and the first electrode from a first voltage to a second voltage, and gradually decreasing the voltage difference from a third voltage to a fourth voltage during the reset period of each subfield of the first subfield group;
gradually increasing the voltage difference from a fifth voltage that is lower than the second voltage to a sixth voltage, and gradually decreasing the voltage difference from a seventh voltage to an eighth voltage during a reset period of each subfield of the second subfield group;
during a first portion of the sustain period of the third subfield group, alternately applying a plurality of first sustain pulses having a first width to the first electrode and the second electrode just before the second subfield group; and
during a second portion of the sustain period of the third subfield group, after the first portion of the sustain period of the third subfield group, alternately applying at least one second sustain pulse having a wider width than the first width to the first electrode and the second electrode.

8. The method of claim 7, wherein a number of pulses in the at least one second sustain pulse in a fourth subfield among the subfields of the third subfield group is less than a number of pulses in the at least one second sustain pulse in a fifth subfield among the subfields of the third subfield group, the fifth subfield comprising a higher weight value than the fourth subfield.

9. The method of claim 8, wherein the at least one second sustain pulse is applied last in the sustain periods of the subfields of the third subfield group.

10. A plasma display configured to display an image during a frame comprising a plurality of subfields, each subfield having a weight value and comprising a reset period, an address period, and a sustain period, the plasma display comprising:
a plurality of discharge cells, wherein each discharge cell is selected as either a light emitting cell or a non-light emitting cell during the address period of each subfield; and
a controller for outputting control signals to a driver,
wherein the controller is configured such that the driver applies a plurality of sustain pulses to the discharge cells during the sustain period, the plurality of sustain pulses comprising a first sustain pulse group and a second sustain pulse group, a sustain pulse of the second sustain pulse group having a wider width than a width of a sustain pulse of the first sustain pulse group, the second sustain pulse group being applied after the first sustain pulse group;
the controller is further configured such that a first discharge cell among the plurality of discharge cells that is selected as the light emitting cell is sustain discharged during sustain periods of subfields of a first subfield group from among the plurality of subfields, and a reset waveform is applied to the first discharge cell in the reset periods of subfields of a second subfield group from among the plurality of subfields, the subfields of the second subfield group being contiguous to the sustain periods of the first subfield group, and
the reset waveform for reset discharging is applied to the light emitting cell during the reset periods of the first subfield group.

11. The plasma display of claim 10, wherein:
a subfield among the plurality of subfields is determined to belong in the first subfield group or the second subfield group according to its weight value, such that the second subfield group comprises subfields having a higher weight value than subfields of the first subfield group; and
a number of pulses in the second sustain pulse group in a subfield of the first subfield group is less than the number of pulses in the second sustain pulse group in a subfield of the second subfield group.

12. The plasma display of claim 11, further comprising:
a plurality of first electrodes; and
a plurality of second electrodes for performing a display operation with the plurality of first electrodes,
wherein the plurality of discharge cells are defined at least in part by the plurality of first electrodes and the plurality of second electrodes;
the driver is configured to alternately apply the second sustain pulse group after alternately applying the first sustain pulse group to the plurality of first electrodes and the plurality of second electrodes during the sustain period, and
the second sustain pulse group comprises a last sustain pulse applied in the sustain period.

13. The plasma display of claim 11, wherein the driver is configured to apply a reset waveform to the plurality of discharge cells during the reset period of at least one subfield of the first subfield group, the reset waveform for discharging the plurality of discharge cells.

14. The plasma display of claim 10, wherein an amount of wall charges formed in the light emitting cell by a sustain discharge by the sustain pulse of the second sustain pulse group is more than an amount of wall charges formed in the light emitting cell by a sustain discharge by the sustain pulse of the first sustain pulse group.
